(19) United States
(12) Patent Application Publication
(10) Pub. No.: US 2024/0027630 A1
(43) Pub. Date: Jan. 25, 2024

(54) REAL-TIME PPE BASE STATION MEASUREMENT UNCERTAINTY MODELING FOR PROTECTION LEVEL COMPUTATION

(71) Applicant: QUALCOMM Incorporated, San Diego, CA (US)

(72) Inventor: Min WANG, Tustin, CA (US)

(21) Appl. No.: 17/814,274

(22) Filed: Jul. 22, 2022

(51) Int. Cl. G01S 19/40; G01S 19/43

(52) U.S. Cl. CPC G01S 19/40; G01S 19/43

(57) ABSTRACT

In some implementations, a mobile device may, for each epoch of a plurality of epochs, determine a respective value of pseudorange noise and multipath error of pseudo-range measurements performed by a global navigation satellite system (GNSS) device. The mobile device may receive the pseudo-range measurements from the GNSS device. The mobile device may determine one or more statistical values of the pseudorange noise and multipath error values for the plurality of epochs. The mobile device may determine a position error (PE) value based on the one or more statistical values. The mobile device may, for at least one epoch of the plurality of epochs, output an indication of the determined PE.

### BACKGROUND

### 1. Field of Disclosure

The present disclosure relates generally to the field of wireless communications, and more specifically to determining the location of a mobile device using radio frequency (RF) signals.

### 2. Description of Related Art

In global navigation satellite system (GNSS)-based positioning of a mobile device (e.g., an electronic device comprising a GNSS receiver), the mobile device may utilize a precise positioning engine (PPE) to determine a high-precision location based on carrier-phase measurements of GNSS signals. This high-precision location can be further based measurement information from a “base station” having a fixed, known location, which can be used to make error corrections in the measurements of the GNSS signals. This base station measurement information may have an intrinsic uncertainty, which may impact the uncertainty of the determined location of the mobile device. However, base station measurement uncertainty is often unavailable to the mobile device, leading to an unknown/unclear level of uncertainty regarding the determined location of the mobile device.

### BRIEF SUMMARY

An example method of real-time precise positioning engine (PPE) measurement uncertainty modeling, according to this disclosure, may comprise, for each epoch of a plurality of epochs, determining a respective value of pseudorange noise and multipath error of pseudo-range measurements performed by a global navigation satellite system (GNSS) device. The method also may comprise determining one or more statistical values of the pseudorange noise and multipath error values for the plurality of epochs. The method also may comprise determining a position error (PE) value based on the one or more statistical values. The method also may comprise for at least one epoch of the plurality of epochs, outputting an indication of the determined PE.

An example mobile device for real-time precise positioning engine (PPE) measurement uncertainty modeling, according to this disclosure, may comprise a transceiver, a memory, one or more processors communicatively coupled with the transceiver and the memory, wherein the one or more processors are configured to for each epoch of a plurality of epochs, determine a respective value of pseudorange noise and multipath error of pseudo-range measurements performed by a global navigation satellite system (GNSS) device. The one or more processors further may be configured to determine one or more statistical values of the pseudorange noise and multipath error values for the plurality of epochs. The one or more processors further may be configured to determine a position error (PE) value based on the one or more statistical values. The one or more processors further may be configured to for at least one epoch of the plurality of epochs, output an indication of the determined PE.

An example apparatus for real-time precise positioning engine (PPE) measurement uncertainty modeling, according to this disclosure, may comprise means for determining for each epoch of a plurality of epochs, a respective value of pseudorange noise and multipath error of pseudo-range measurements performed by a global navigation satellite system (GNSS) device. The apparatus further may comprise means for determining one or more statistical values of the pseudorange noise and multipath error values for the plurality of epochs. The apparatus further may comprise means for determining a position error (PE) value based on the one or more statistical values. The apparatus further may comprise means for outputting an indication of the determined PE for at least one epoch of the plurality of epochs.

According to this disclosure, an example non-transitory computer-readable medium stores instructions for real-time precise positioning engine (PPE) measurement uncertainty modeling, the instructions comprising code for, for each epoch of a plurality of epochs, determining a respective value of pseudorange noise and multipath error of pseudo-range measurements performed by a global navigation satellite system (GNSS) device. The instructions further may comprise code for determining one or more statistical values of the pseudorange noise and multipath error values for the plurality of epochs. The instructions further may comprise code for determining a position error (PE) value based on the one or more statistical values. The instructions further may comprise code for, for at least one epoch of the plurality of epochs, outputting an indication of the determined PE.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a global navigation satellite system (GNSS) system.

FIG. 2 is a simplified diagram of an Real Time Kinematic (RTK) system, according to an embodiment.

FIG. 3 is a flow diagram illustrating how correction data from an RTK base station can be used to mitigate errors sources in a precise positioning engine (PPE) location determination for mobile device.

FIG. 4 is an illustration of a graph that shows different operational states of a GNSS device (e.g., a mobile device) based on different values of protection level and position error.

FIG. 5 is a flow diagram illustrating a general method for modeling measurement uncertainty for pseudo-range and carrier phase measurements.

FIGS. 6A and 6B are diagrams plotting simulated horizontal error and corresponding horizontal protection level values for a series of epochs.

FIG. 7 is a flow diagram of a method of real-time PPE measurement uncertainty modeling, according to an embodiment.

FIG. 8 is a block diagram of various hardware and software components of a mobile device, according to an embodiment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure.

As described herein, a satellite receiver, such as a Global Navigation Satellite Systems (GNSS) receiver, may be integrated into a mobile device comprising an electronic device or system. Such a mobile device can include, for example, consumer, industrial, and/or commercial electronics, vehicles, assets, vessels, and the like. As described herein, a location estimate of the satellite receiver or mobile device into which the satellite receiver is integrated may be referred to as a location, location estimate, location fix, fix, position, position estimate, or position fix of the satellite receiver or mobile device. Moreover, the location estimate may be geodetic, thus providing location coordinates for the mobile device (e.g., latitude and longitude) which may or may not include an altitude component (e.g., height above sea level, height above or depth below ground level, floor level, or basement level). In some embodiments, a location of the satellite receiver and/or mobile device comprising the satellite receiver may also be expressed as an area or volume (defined either geodetically or in civic form) within which the satellite receiver is expected to be located with some probability or confidence level (e.g., 67%, 95%, etc.). In the description contained herein, the use of the term location may comprise any of these variants unless indicated otherwise. When computing the location of a satellite receiver, such computations may solve for local X, Y, and possibly Z coordinates and then, if needed, convert the coordinates from one coordinate frame to another.

As used herein, the terms “position” and “location” are used interchangeably. Further, terms such as “position determination,” “position fix,” “location estimate,” “estimated location,” “location fix,” and the like are also used interchangeably herein with regard to GNSS-based positioning to refer to an estimated position of a mobile device or other device comprising a GNSS receiver. The position or location may be a two-dimensional position, e.g., with regard to two-dimensional map, or a three-dimensional position.

Additionally, as used herein, the terms “correction data,” “base station measurement data,” and/or variants thereof may refer to corrective information provided by a Real-Time Kinematic (RTK) service provided to enable a high-accuracy position determination of a device having a GNSS receiver. Correction data can include measurement data taken by a reference station and/or corrective information derived from the measurement data, such as a difference between a true range determination, based on a known location of a reference station, and a measurement performed at the reference station. Corrective data can be used as described herein, along with measurements performed at the device having the GNSS receiver, to determine the high-accuracy position of the device.

As noted, a high-accuracy position of a mobile device may be determined by a precise positioning engine (PPE) that leverages correction data/measurement information from an RTK base station to perform error correction on GNSS measurements (e.g., carrier-phase measurements), enabling the PPE to determine a high-precision (e.g., centimeter-level accuracy) location determination of the mobile device. However, the correction data/measurement information from the RTK base station may have errors that may lead to a degree of uncertainty for the correction data/measurement information. If these errors are unaccounted for, the accuracy and/or integrity of the determined location of the mobile device may be compromised in certain circumstances. Embodiments herein are directed toward modeling error sources to help mitigate and/or account for error and uncertainty related to the location of a mobile device. It can be noted that, although embodiments herein described modeling uncertainty with respect to base station measurements, embodiments are not so limited. The techniques described herein may be applied to model uncertainty with respect to other GNSS devices, such as the mobile device. A detailed description of these techniques and embodiments will be provided after a review of related technologies.

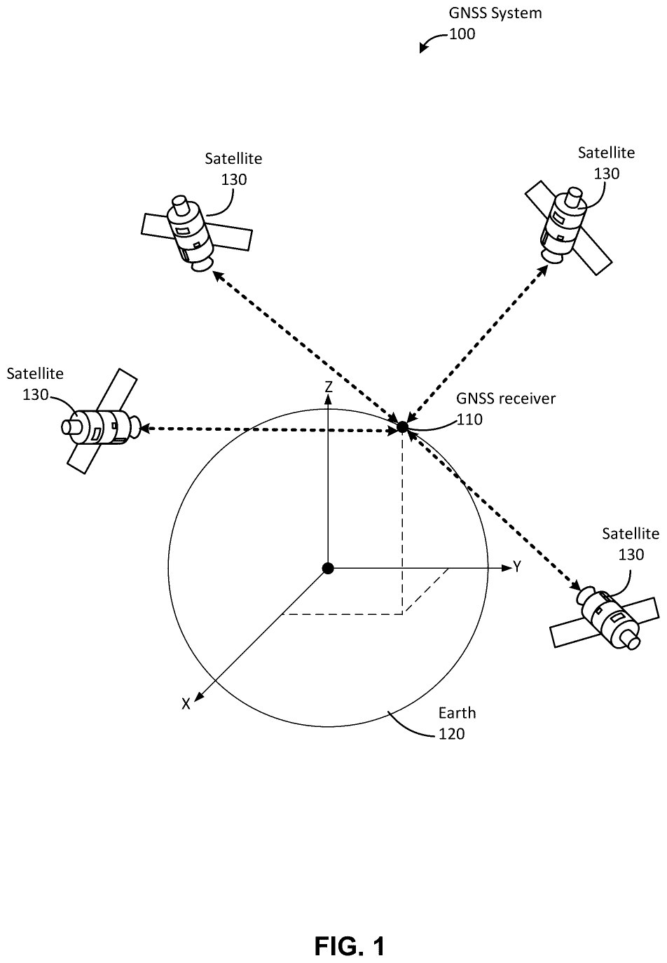

FIG. 1 is a simplified diagram of a GNSS system 100, provided to illustrate how GNSS is generally used to determine an accurate location of a GNSS receiver 110 on earth 120 (also known as “positioning” of the GNSS receiver). Put generally, the GNSS system 100 enables an accurate GNSS position fix of the GNSS receiver 110, which receives radio frequency (RF) signals from GNSS satellites 130 from one or more GNSS constellations. (A satellite such as GNSS satellites 130 may also be referred to herein as a space vehicle (SV).) The types of GNSS receiver 110 used may vary, depending on application. In some embodiments, for instance, the GNSS receiver 110 may comprise consumer electronics or devices, such as a mobile phone, tablet, laptop, wearable device, vehicle (or on-vehicle device), or the like. In some embodiments, the GNSS receiver 110 may comprise industrial or commercial equipment, such as survey equipment.

It will be understood that the diagram provided in FIG. 1 is greatly simplified. In practice, there may be dozens of satellites 130 and a given GNSS constellation, and there are many different types of GNSS systems. GNSS systems include, for example, Global Positioning System (GPS), Galileo (GAL), GLONASS, Quasi-Zenith Satellite System (QZSS) over Japan, Indian Regional Navigational Satellite System (IRNSS) over India, BeiDou Navigation Satellite System (BDS), and/or the like. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on multilateration, which is a method of determining position by measuring distances to points at known coordinates. In general, the determination of the position of a GNSS receiver 110 in three dimensions may rely on a determination of the distance between the GNSS receiver 110 and four or more satellites 130. As illustrated, 3D coordinates may be based on a coordinate system (e.g., XYZ coordinates; latitude, longitude, and altitude; etc.) centered at the earth's center of mass. A distance between each satellite 130 and the GNSS receiver 110 may be determined using precise measurements made by the GNSS receiver 110 of a difference in time from when a radio frequency RF signal is transmitted from the respective satellite 130 and when it is received at the GNSS receiver 110. To help ensure accuracy, not only does the GNSS receiver 110 need to make an accurate determination of when the respective signal from each satellite 130 is received, but many additional factors need to be considered and accounted for. These factors include, for example, clock differences at the GNSS receiver 110 and satellite 130 (e.g., clock bias), a precise location of each satellite 130 at the time of transmission (e.g., as determined by the broadcast ephemeris), the impact of atmospheric distortion (e.g., ionospheric and tropospheric delays), and the like.

To perform a traditional GNSS position fix, the GNSS receiver 110 can use code-based positioning to determine its distance to each satellite 130 based on a determined delay in a generated pseudorandom binary sequence received in the RF signals received from each satellite, in consideration of the additional factors and error sources previously noted. With the distance and location information of the satellites 130, the GNSS receiver 110 can then determine a position fix for its location. This position fix may be determined, for example, by a Standalone Positioning Engine (SPE) executed by one or more processors of the GNSS receiver 110. However, code-based positioning is relatively inaccurate and, without error correction, is subject to many of the previously described errors. Even so, code-based GNSS positioning can provide a positioning accuracy for the GNSS receiver 110 on the order of meters.

More accurate carrier-based ranging is based on a carrier wave (carrier phase) of the RF signals from satellites and may use measurements at a base or reference station (not shown) to perform error correction to help reduce errors from the previously noted error sources. More specifically, errors (e.g., atmospheric errors sources) in the carrier-based ranging of satellites 130 observed by the GNSS receiver 110 can be mitigated or canceled based on similar carrier-based ranging of the satellites 130 using a highly accurate GNSS receiver at the base station at a known location. These measurements and the base station's location can be provided to the GNSS receiver 110 for error correction. This position fix may be determined, for example, by a Precise Positioning Engine (PPE) executed by one or more processors of the GNSS receiver 110. More specifically, in addition to the information provided to an SPE, the PPE may use base station GNSS measurement information, and additional correction information, such as precise orbit and clock, troposphere and ionosphere, to provide a high accuracy, carrier-based position fix. Several GNSS techniques can be adopted in PPE, such as Differential GNSS (DGNSS), Real Time Kinematic (RTK), and PPP, and may provide a sub-meter accuracy (e.g., on the order of centimeters).

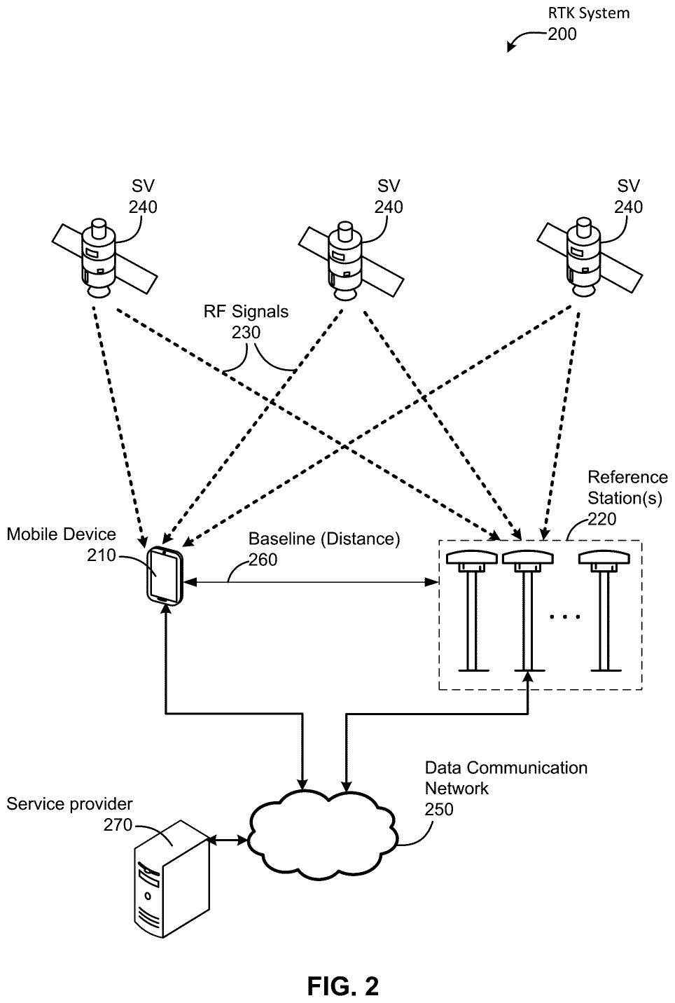

FIG. 2 is a simplified diagram of an RTK system, according to an embodiment. The RTK system 200 can be used in conjunction with a GNSS system (e.g., GNSS system 100) to enable a highly accurate (e.g., sub-meter) GNSS position fix of a mobile device 210 (also known as a “rover station” or “rover”) by using GNSS receivers at both the mobile device 210 and one or more base stations 220 (also known as “reference stations”) that receive radio frequency (RF) signals 230 from satellite vehicles (SVs) 240 (GNSS satellites) from one or more GNSS constellations (e.g., Global Position System (GPS), Galileo (GAL), global navigation Satellite System (GLONASS), Beidou, etc.). (SVs 240 may correspond with GNSS satellites 130 of FIG. 1.) Again, types of mobile devices 210 used may vary, depending on application, and may include any of a variety of types of devices having access to GNSS positioning data, such as mobile devices equipped with GNSS receivers.

RTK positioning can provide an accurate carrier-based ranging solution (e.g., on the order of centimeters or decimeters) based on the phase of the carrier wave of the RF signals 230. RTK positioning can use a reference station 220 to make measurements of RF signals 230 with a highly-accurate GNSS receiver from a known location. Unlike DGNSS, however, RTK correction data/measurement data (also known as “RTK service data”) includes highly-accurate carrier-based ranging. RTK correction data may be related to the mobile device 210 via radio broadcasts and/or data communication network 250. The mobile device 210 can then use the RTK correction data to correct errors in its own carrier-based ranging using measurements of the RF signals 230 from its own GNSS receiver. Error correction for RTK positioning can include correction of satellite clock and orbit, ionospheric and tropospheric delays, phase wind-up, site displacement including solid earth tide, ocean loading, and/or pole tide. This more accurate position fix (i.e., position) may be determined, for example, by a PPE executed by one or more processors of the mobile device 210. More specifically, in addition to the information provided to an SPE, the PPE may use RTK correction data, to provide a high accuracy, carrier-based position fix. Several GNSS techniques can be adopted in PPE, such as DGNSS, RTK, and PPP.

A mobile device 210 can determine its position using a location/position estimator or positioning engine (e.g., PPE) that incorporates ambiguity resolution and differential correction. The location/position estimator may use estimation techniques such as by using an Extended Kalman Filter (EKF), Weighted Least Squares (WLS), particle filter, or the like. The accuracy of the position fix for the mobile device 210 can depend on its distance, or “baseline” 260, from the reference station 220; the accuracy of the differential corrections; and the like. Although traditional DGNSS and RTK correction has been limited to a baseline 260 on the order of kilometers or tens of kilometers, new techniques may extend the baseline 260 to far greater distances using enhanced techniques for error correction. For example, Ultra-Long Baseline RTK (ULB-RTK) can use a multi-constellation, multi-frequency (MCMF) GNSS receiver at the mobile device 210 and tropospheric modeling to perform correction of errors arising from ionospheric and tropospheric delays, allowing for a baseline 260 of up to 1000 km or more. Because of this increased distance, there may be fewer SVs 240 that are observable by both the mobile device 210 and the reference station 220. These SVs 240 are referred to herein as “common-view satellites.”

RTK positioning can be further enhanced using network-based techniques. In the network-based DGNSS/RTK, correction data from a plurality of reference stations 220 is sent to a service provider 270. The mobile device 210 can then receive on-demand RTK correction data by sending a request to the service provider 270, including an approximate location of the mobile device 210 (e.g., based on a previously-known position, non-GNSS-based positioning (such as a tracking area in a wireless communications network or dead reckoning-based positioning of a vehicle), etc.). The service provider 270, which may comprise one or more computer servers, can then provide customized RTK service data for the mobile device 210 by interpolating the correction data from the plurality of reference stations 220 to provide RTK service data for the approximate location of the mobile device 210. To interpolate the correction data, the service provider 270 may execute sophisticated GNSS algorithms based on the geometry of the reference stations 220 used. Because of the sophistication of the interpolated solution, the convergence time (the length of time it takes to obtain a high-accuracy position determination) can be relatively long.

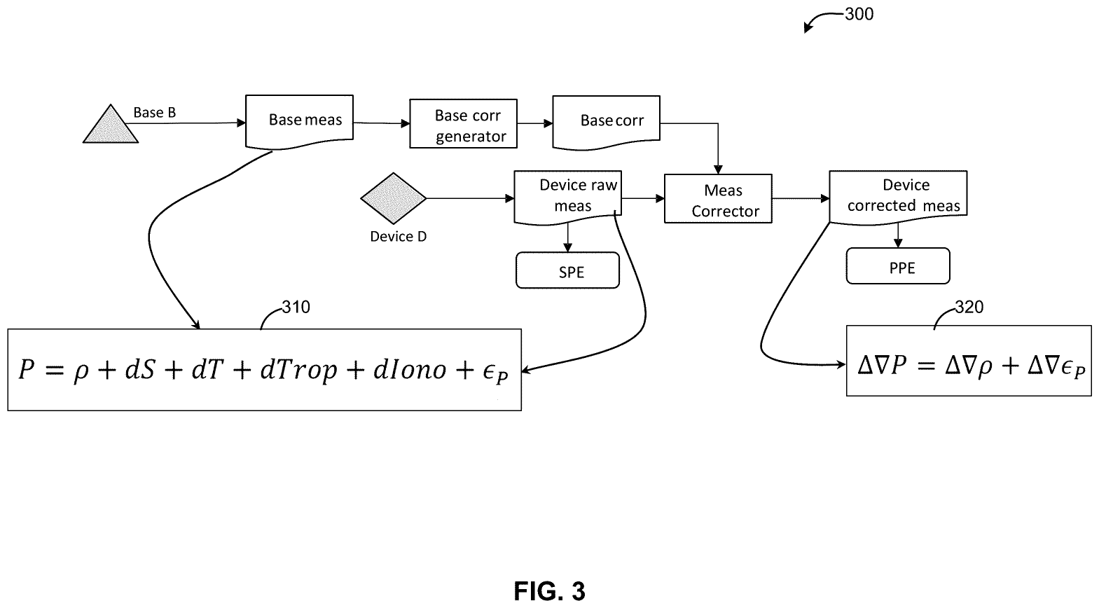

FIG. 3 is a flow diagram 300 illustrating how correction data from an RTK base station can be used to mitigate errors sources in a PPE/high-precision location determination for mobile device. Here, both a base station (“Base B”) and a mobile device (“Device D”) take pseudo-range measurements of GNSS signals. The respective raw pseudo-range measurements, P, represented by the equation in block 310, includes the true range ρ, with additional errors from a variety of errors sources. This includes, for example, dS (errors from satellite orbit, clock, and differential code bias (DCB)), dT (receiver clock errors), dTrop (tropospheric delay residual error after applying a tropospheric model), dIono (ionospheric delay residual error after applying an ionospheric model), and Ep (noise and high-frequency multipath). As indicated, and SPE can use the raw pseudo-range measurement to determine a location of the mobile device, although it may be subject to these various errors. By taking the difference between pseudo-range measurements performed by the base station and the mobile device, most errors can be removed (e.g., at the mobile device after receiving measurement/correction information from the base station). As shown in the equation of block 320, the only remaining error sources for the double-differenced pseudo-range measurements, Δ∇P, comprise Δ∇ϵ_{P} (noise and high-frequency multipath) (where Δ∇ρ is the true range). Although not shown in FIG. 3, a PPE also may use carrier phase measurements in a similar manner to provide a high-accuracy position estimate.

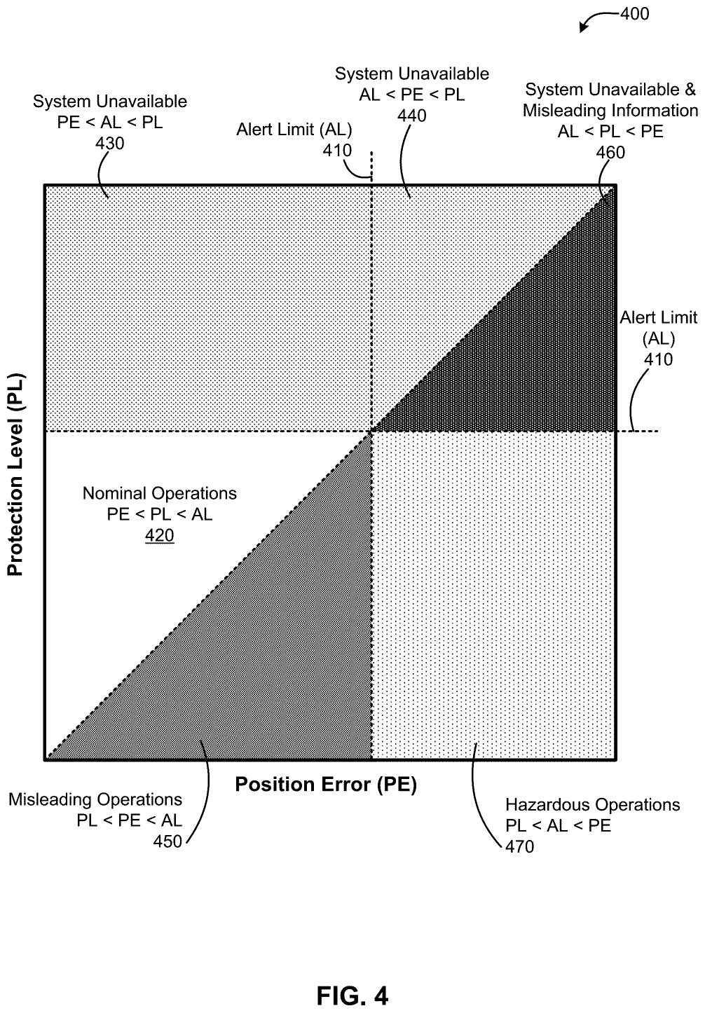

The use of correction data from a base station in determining a position estimate for mobile device may call into question the uncertainty of the base station's measurements. That is, aspects of the position estimate for the mobile device such as position error (PE) and/or protection level (PL) may be impacted based on an uncertainty of the measurements made by the base station. FIG. 4, described hereafter, provides additional detail.

FIG. 4 is an illustration of a graph 400 that plots protection level (PL) over position error (PE). As illustrated, the graph 400 may be split into various regions defining operational states that reflect the integrity of the position determination (e.g., for a mobile device). This is known as the “Stanford diagram,” and is used in various applications, especially applications where safety is a concern, such as autonomous driving, airplanes, etc. The various regions are defined based on PL and PE, along with an alert limit (AL) 410 representing PL and PE thresholds.

Generally put, the PL is used as bound for PE (e.g., to determine normal operations 420) and may be determined based on PE. For example, the horizontal PL (HPL) may be calculated using the equation:

HPL=HPL₀+HPL₁, (1)

where the terms, HPL₀ and HPL₁ may be calculated using the following equations:

HPL₀=K(P_{IR})*dₘₐⱼₒᵣ, (2)

and

HPL₁=\sqrt{T}*^{max}ᵢ(hslopeᵢ*σₛₕ). (3)

In equations (2) and (3) K(P_{IR}) is an inflation factor as a function of integrity risk requirement, dₘₐⱼₒᵣ is the semi-major axis of the horizontal error ellipse, hslope is the projection of a line-of-sight vector onto the horizontal domain, T is a threshold called Normalized Sum of Squared Error (NSSE) computed as T=r^{T}C⁻¹r, where r is the measurement residual vector and C is the measurement uncertainty covariance matrix, and σₛₕ is an uncertainty corresponding to the max hslope satellite. Importantly, a knowledge of the uncertainty is used to determine these values. For example, dₘₐⱼₒᵣ is determined from the horizontal uncertainty of position error (HEPE), and σₛₕ is determined from the uncertainty model for the base station

As shown in FIG. 4, the various operational states are defined by the relationship between PE, AL, and PL. For example, normal operation 420 occurs when PL is greater than PE, and both PL and PE are less than AL. Other operational states include states in which the system is unavailable 430, 440, misleading operations 450, system is unavailable/misleading operations 460, and hazardous operations 470.

The PE and PL, and the various regions illustrated in the graph 400 are computed based on an accurate description of GNSS error sources. As noted, the term σₛₕ, used to determine the PL, can be derived from the uncertainty model for the base station. If the error sources are not properly modeled or described in real time, the protection levels may be optimistic (resulting in misleading information or hazardous operation) and pessimistic (reducing the system availability). Thus, modeling of the base station measurement uncertainty can help ensure the integrity of the states of operation as defined by graph 400 (or similar operational states).

To address these and other concerns, embodiments herein provide for real-time base station measurement uncertainty modeling, which may be performed by a PPE. This can provide a determination of pseudo-range measurement quality for base station in real-time operation, without need of offline pre-computation. Further, according to some embodiments, the techniques provided herein provide a geometry-free approach that does not depend on base station position accuracy. This means the techniques provided herein also may be applicable to moving base stations. Further, as previously noted, techniques provided herein can also provide for measurement uncertainty modeling for the mobile device (e.g., executing the PPE) in case a model for the measurement uncertainty for the mobile device is inaccurate or unavailable. Among other benefits, embodiments can provide for better position accuracy (HE) and/or better HEPE determination (e.g., by taking into account errors at the base station), therefore benefiting to PL computation (and the integrity of operational states reliant thereon, such as those shown in FIG. 4).

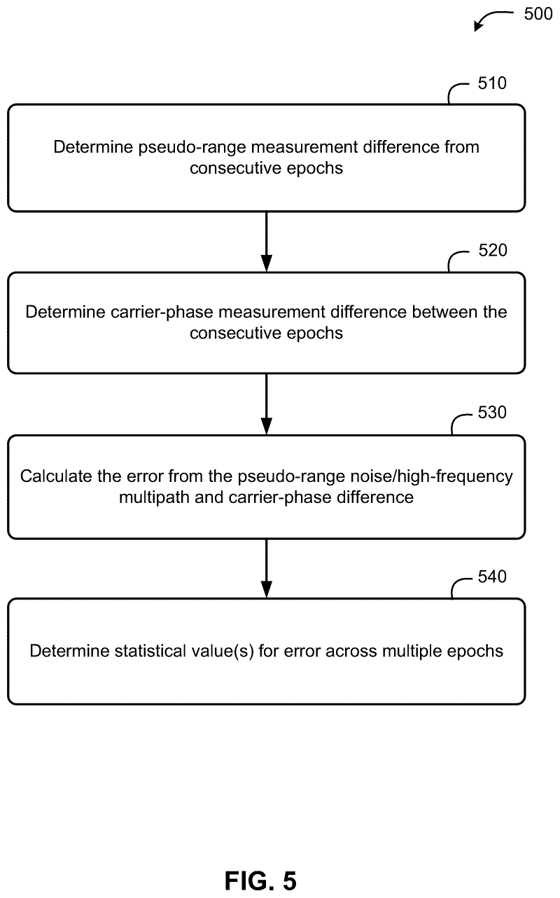

FIG. 5 is a flow diagram illustrating a general method for modeling measurement uncertainty for pseudo-range and carrier phase measurements. As noted above, this may be executed by a PPE in real time. Base station measurement uncertainty may be determined by a mobile device, for example, using measurement data received from the base station. Additionally or alternatively, as also noted, mobile device measurement uncertainty may be modeled in cases where the measurement uncertainty model is otherwise unavailable.

At block 510, the functionality comprises determining pseudo-range difference from consecutive epochs. For epochs at times tᵢ and tⱼ, the pseudo-range measurements may be represented as follows:

P(tᵢ)=ρ(tᵢ)+dS(tᵢ)+dT(tᵢ)+dTrop(tᵢ)+dIono(tᵢ)+ϵ_{P}(tᵢ), P(tⱼ)=ρ(tⱼ)+dS(tⱼ)+dT(tⱼ)+dTrop(tⱼ)+dIono(tⱼ)+Ep(tⱼ), (4)

where the various components/error sources of the equations (4) reflect those shown in FIG. 3 and described previously. Here, the following errors are approximately the same in successive epochs (e.g., epochs that are 1 second apart):

dS(tᵢ)≈dS(tⱼ), dTrop(tᵢ)≈dTrop(tⱼ), and dIono(tᵢ)≈dIono(tⱼ). (5)

Further, ϵ_{P}(tⱼ) is the same level as ϵ_{P}(tᵢ). Thus, the difference between pseudo-range measurements between successive epochs at times tᵢ and tⱼ may be computed as:

P(tⱼ)−P(tᵢ)=[ρ(tⱼ)−ρ(tᵢ)]+[dT(tⱼ)−dT(tᵢ)]+\sqrt{2}ϵ_{P}(tⱼ). (6)

where \sqrt{2}ϵβ(tⱼ) represents the noise and multipath.

At block 520, a similar process may be performed to determine a carrier-phase difference between the consecutive epochs. The carrier-phase measurements at times tᵢ and tⱼ may be represented as follows:

Φ(tᵢ)=ρ(tᵢ)+dS(tᵢ)+dT(tᵢ)+dTrop(tᵢ)−dIono(tᵢ)+λN+ϵ_{Φ}(tᵢ), Φ(tⱼ)=ρ(tⱼ)+dS(tⱼ)+dT(tⱼ)+dTrop(tⱼ)−dIono(tⱼ)+ΔN+ϵ_{Φ}(tⱼ), (7)

Again, most values are approximately the same between the two epochs and may be canceled out when taking the difference between Φ(tᵢ) Φ(tⱼ). This includes λN (the integer number of wavelengths, where N is the ambiguity term), because there is no cycle slip between the two epochs. Further, the values for the noise level (ϵ_{Φ}) for both epochs may be ignored, given how relatively small they are compared with the other terms. (In many implementations, for example, the noise may be on the order of 2 mm.) With these considerations, the difference between the equations (7) may be represented as follows:

Φ(tⱼ)−Φ(tᵢ)=[ρ(tⱼ)−ρ(tᵢ)]+[dT(tⱼ)−dT(tᵢ)]. (8)

Equations (6) and (8) can be used to solve for the term for noise and multipath, \sqrt{2}ϵ_{P}(tⱼ), resulting in the following equation:

$${ϵ}_{P} ( {t}_{j} ) = \frac{[ P ( {t}_{j} ) - P ( {t}_{i} ) ] - [ Φ ( {t}_{j} ) - Φ ( {t}_{i} ) ]}{\sqrt{2}} . \qquad ( 9 )$$

This allows for a determination of the error due to noise and multipath error at time tⱼ, which is the functionality shown at block 530 in FIG. 5. Additionally, by further solving for this noise/multipath error across multiple successive epochs (e.g., 5, 10, 15, 20, 30, or 60 epochs, or more, representing successive epochs tₖ, tₗ, tₘ, etc.), statistical values of the noise/multipath error can be determined, such as the standard deviation (STD) value, root mean square (RMS) value, and/or the like. In some embodiments, the number of successive epochs used to determine the statistical value(s) may be adjusted, based on a setting (e.g., at the mobile device). This determination of one or more such statistical values is shown at block 540 of the method 500 of FIG. 5. The statistical value(s) of the noise/multipath error can provide for an accurate modeling of the measurement uncertainty for pseudo-range and carrier phase measurements of the base station (or whatever device made the pseudo-range and carrier phase measurements used at blocks 510 and 520 in FIG. 5).

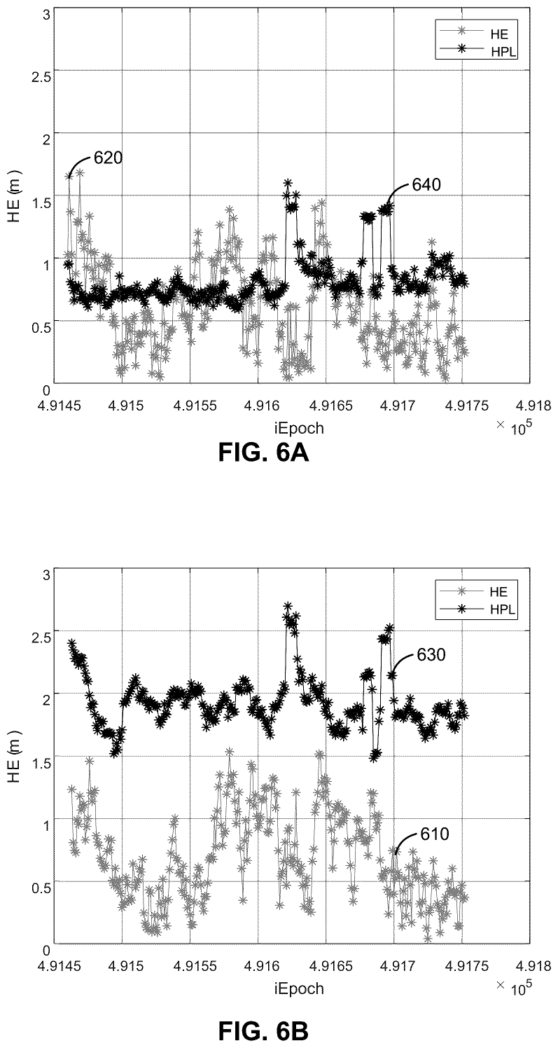

Values for the noise/multipath error at the base station can be used in determining values for PE (e.g., HEPE) and PL (e.g., HPL, using equations (1)-(3)). This can help reduce the value of PE, and increase the accuracy of the corresponding PL. An example of this is illustrated in FIGS. 6A and 6B.

FIGS. 6A and 6B are diagrams plotting simulated horizontal PE (HE) and corresponding HPL values for a series of epochs. FIG. 6A shows HE and HPL values when uncertainty at a base station is unknown, and FIG. 6B shows HE and HPL values (using the same pseudo-range and carrier phase measurements as used in FIG. 6A) when uncertainty at base station is modeled using the techniques described herein.

As can be seen, there are various improvements in the values of FIG. 6B over those of FIG. 6A. For example, HE values 610 in FIG. 6B have been slightly improved (reduced) over corresponding HE values 620 in FIG. 6A. Furthermore, HPL values 630 in FIG. 6B have increased significantly over corresponding HPL values 640 in FIG. 6A. This illustrates a significant increase in accuracy of uncertainty in the values of FIG. 6B over those of FIG. 6A. A more accurate determination of HPL values can lead to a more accurate determination of operational states (e.g., using the graph 400 in FIG. 4), providing for a system with higher integrity, potentially increasing the safety of people and/or cargo in a system (e.g., of vehicle such as a car or airplane) reliant on an accurate determination of such operational states.

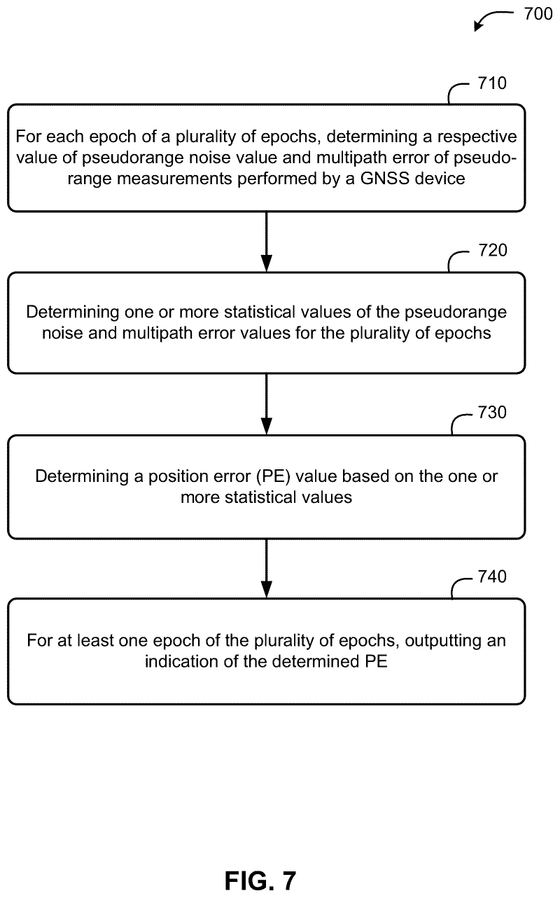

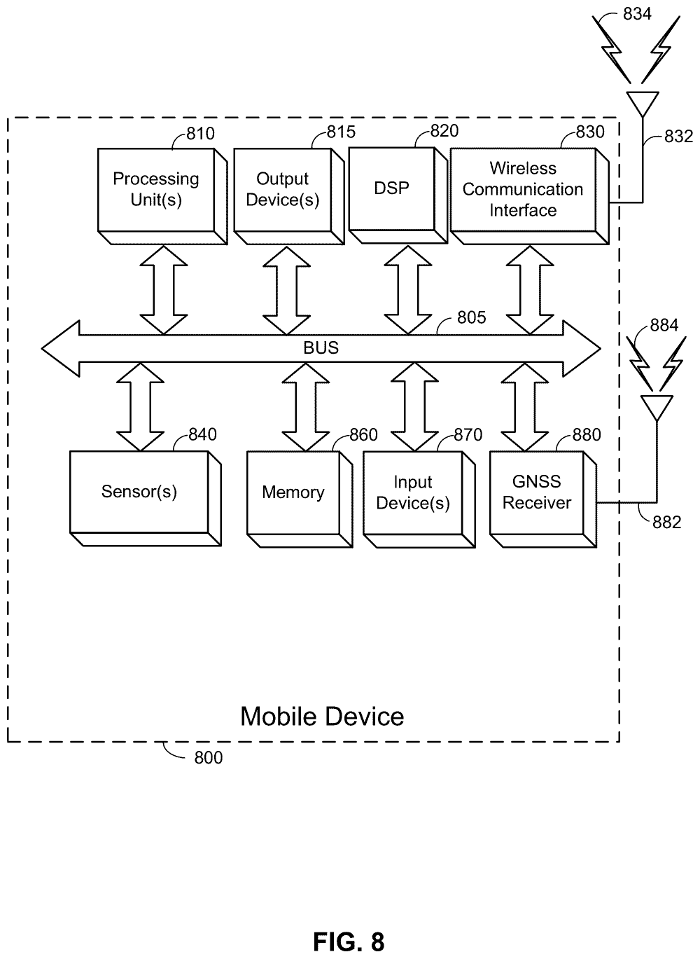

FIG. 7 is a flow diagram of a method 700 of real-time PPE measurement uncertainty modeling, according to an embodiment. Means for performing the functionality illustrated in one or more of the blocks shown in FIG. 7 may be performed by hardware and/or software components of a device, such as a mobile device that receives measurement/correction information from a base station (e.g., RTK base station). Example components of a mobile device are illustrated FIG. 8, which is described in more detail below.

At block 710, the functionality comprises, for each epoch of a plurality of epochs, determining a respective value of pseudorange noise value and multipath error of pseudo-range measurements performed by a GNSS device. This can be done, for example, using the previously-describe process illustrated in FIG. 5. For any given epoch, for example, a value of pseudo-range noise and multipath (ϵ_{P}) may be calculated using equation (9) from pseudo-range and carrier-phase measurements from both the epoch (e.g., tⱼ) and the preceding epoch (e.g., tᵢ). As noted elsewhere herein, the uncertainty can be calculated for base station or a mobile device. As such, according to some embodiments of the method 700, the GNSS device that takes the may comprise an RTK base station or a mobile device.

Means for performing functionality at block 710 may comprise a bus 805, processing unit(s) 810, DSP 820, wireless communication interface 830, memory 860, GNSS receiver 880, and/or other components of a mobile device 800, as illustrated in FIG. 8 and described in more detail hereafter.

At block 720, the functionality comprises determining one or more statistical values of the pseudorange noise and multipath error values for the plurality of epochs. As previously indicated, statistical values may include STD, RMS, and/or other values representative of the pseudo-range noise and multipath error across multiple epochs (e.g., averages, means, etc.). As noted elsewhere herein, the number of epochs (e.g. in the plurality of epochs) can vary, depending on desired functionality. In some embodiments, for example, the number of epochs used to determine the statistical values may comprise 10, 20, 30, or 60 epochs, for example. Alternative embodiments may utilize a different number.

Means for performing functionality at block 720 may comprise a bus 805, processing unit(s) 810, DSP 820, wireless communication interface 830, memory 860, GNSS receiver 880, and/or other components of a mobile device 800, as illustrated in FIG. 8 and described in more detail hereafter.

At block 730, the functionality comprises determining a PE value based on the one or more statistical values. As illustrated in FIGS. 6A and 6B, for example, this value may comprise a horizontal error (HE). Additionally or alternatively, this value may comprise a horizontal uncertainty of position error (HEPE).

Means for performing functionality at block 730 may comprise a bus 805, processing unit(s) 810, DSP 820, wireless communication interface 830, memory 860, GNSS receiver 880, and/or other components of a mobile device 800, as illustrated in FIG. 8 and described in more detail hereafter.

At block 740, the functionality comprises for at least one epoch of the plurality of epochs, outputting an indication of the determined PE. In some embodiments, the indication may comprise an HE and/or HEPE value. In some embodiments, the output may be provided by one component of a device to another. For example, a GNSS engine executing a PPE may output the HE/or HEPE value to a component such as an application processor. Additionally or alternatively, the PPE may output the PE (or derivative value) application, or operating system, or other software layer.

Means for performing functionality at block 740 may comprise a bus 805, processing unit(s) 810, DSP 820, wireless communication interface 830, memory 860, GNSS receiver 880, and/or other components of a mobile device 800, as illustrated in FIG. 8 and described in more detail hereafter.

As indicated in the previously-described embodiments, one or more additional features may be implemented, depending on desired functionality. For example, according to some embodiments of the method 700, the method may further comprise determining a PL based at least in part on the PE value, for at least one epoch of the plurality of epochs, outputting an indication of the determined PL. according to some embodiments, this may comprise outputting an indication of an operational state (e.g., as described previously with regard to FIG. 4). Moreover, as indicated with respect to the method 500 illustrated in FIG. 5, embodiments may further comprise, for each epoch of the plurality of epochs, determining the respective pseudorange noise value and the respective multipath error value is based on a difference in the respective pseudorange value for the respective epoch with a pseudorange value for a preceding epoch (e.g., the epoch immediately preceding the respective epoch), and a difference in the carrier phase value for the respective epoch with a carrier phase value for the preceding epoch. In some embodiments, the PE value may comprise a HEPE value and/or the PL may comprise an HPL.

As noted herein, embodiments of the method 700 may be implemented by mobile device that receives measurement/error correction information from a base station. For embodiments in which the GNSS device comprises an RTK base station, a mobile device may perform the determining of the value of the respective pseudorange noise and the respective multipath error for each epoch of the plurality of epochs based, at least in part, on information received by the mobile device indicative of the pseudo-range measurements performed by the RTK base station. According to some embodiments, the method may further comprise, for at least one epoch of the plurality of epochs determining a GNSS-based position of the mobile device based, at least in part, on the information received by the mobile device indicative of the pseudo-range measurements performed by the RTK base station; and outputting an indication of the GNSS-based position. In such embodiments, the determined PL and/or PE values may correspond with the GNSS-based position. According to some embodiments, for example, an operating status (e.g., as indicated in FIG. 4) may accompany a GNSS-based position. Again, this information may be provided by one component of a mobile device to another (e.g., from a PPE to an application processor, operating system, application, etc.).

FIG. 8 is a block diagram of various hardware and software components of a mobile device 800, according to an embodiment. These components can be utilized as described herein above (e.g. in association with FIGS. 1-7). For example, the mobile device 800 can perform the operations of the method illustrated in FIGS. 5 and/or 7, and/or one or more of the functions of a mobile device 800 as described in the embodiments herein. It should be noted that FIG. 8 is meant only to provide a generalized illustration of various components, any or all of which may be utilized as appropriate. As previously noted, mobile device 800 may vary in form and function, and may ultimately comprise any GNSS-enabled device, including vehicles, commercial and consumer electronic devices, survey equipment, and more. Thus, in some instances, components illustrated by FIG. 8 can be localized to a single physical device and/or distributed among various networked devices, which may be disposed at different physical locations (e.g., different locations of a vehicle). It can be further noted that reference stations may utilize hardware and/or software components similar to the mobile device 800 to provide the functionality described herein.

The mobile device 800 is shown comprising hardware elements that can be electrically coupled via a bus 805 (or may otherwise be in communication, as appropriate). The hardware elements may include a processing unit(s) 810 which can include without limitation one or more general-purpose processors, one or more special-purpose processors (such as digital signal processing (DSP) chips, graphics processing units (GPUs), application specific integrated circuits (ASICs), and/or the like), and/or other processor, processing structure, or processing means. As shown in FIG. 8, some embodiments may have a separate Digital Signal Processor (DSP) 820, depending on desired functionality. Location determination and/or other determinations based on wireless communication may be provided in the processing unit(s) 810 and/or wireless communication interface 830 (discussed below). The mobile device 800 also can include one or more input devices 870, which can include without limitation a keyboard, touch screen, a touch pad, microphone, button(s), dial(s), switch(es), and/or the like; and one or more output devices 815, which can include without limitation a display, light emitting diode (LED), speakers, and/or the like. As will be appreciated, the type of input devices 870 and output devices 815 may depend on the type of mobile device 800 with which the input devices 870 and output devices 815 are integrated.

The mobile device 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX™ device, a Wide Area Network (WAN) device and/or various cellular devices, etc.), and/or the like, which may enable the mobile device 800 to communicate via networks and/or directly with other devices as described herein. The wireless communication interface 830 may permit data and signaling to be communicated (e.g. transmitted and received) with a network, for example, via WAN access points, cellular base stations and/or other access node types, and/or other network components, computer systems, and/or any other electronic devices described herein. The communication can be carried out via one or more wireless communication antenna(s) 832 that send and/or receive wireless signals 834. The antenna(s) 832 may comprise one or more discrete antennas, one or more antenna arrays, or any combination.

Depending on desired functionality, the wireless communication interface 830 may comprise separate transceivers, a separate receiver and transmitter, or any combination of transceivers, transmitters, and/or receivers to communicate with base stations and other terrestrial transceivers, such as wireless devices and access points. The mobile device 800 may communicate with different data networks that may comprise various network types. For example, a Wireless Wide Area Network (WWAN) may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX™ (IEEE 802.16) network, and so on. A CDMA network may implement one or more radio access technologies (RATs) such as CDMA2000®, Wideband CDMA (WCDMA), and so on. CDMA2000® includes IS-95, IS-2000, and/or IS-856 standards. A TDMA network may implement Global System for Mobile Communications (GSM), Digital Advanced Mobile Phone System (D-AMPS), or some other RAT. An OFDMA network may employ Long-Term Evolution (LTE), LTE Advanced, 5G NR, 6G, and so on. 5G NR, LTE, LTE Advanced, GSM, and WCDMA are described in documents from the Third Generation Partnership Project (3GPP™). CDMA2000® is described in documents from a consortium named “3rd Generation Partnership Project 2” (3GPP2). 3GPP™ and 3GPP2 documents are publicly available. A wireless local area network (WLAN) may also be an IEEE 802.11x network, and a wireless personal area network (WPAN) may be a Bluetooth® network, an IEEE 802.15x, or some other type of network. The techniques described herein may also be used for any combination of WWAN, WLAN and/or WPAN.

The mobile device 800 can further include sensor(s) 840. Sensors 840 may comprise, without limitation, one or more inertial sensors and/or other sensors (e.g., accelerometer(s), gyro scope(s), camera(s), magnetometer(s), altimeter(s), microphone(s), proximity sensor(s), light sensor(s), barometer(s), and the like), some of which may be used to complement and/or facilitate the location determination described herein, in some instances.

Embodiments of the mobile device 800 may also include a GNSS receiver 880 capable of receiving signals 884 from one or more GNSS satellites (e.g., satellites 130 of FIG. 1 and/or SVs 240 of FIG. 2) as described herein using an antenna 882 (which could be the same as antenna 832). The GNSS receiver 880 can extract a position of the mobile device 800, using conventional techniques, from GNSS SVs of a GNSS system (e.g., satellites 130 of FIG. 1 and/or SVs 240 of FIG. 2), such as GPS, GAL, Global Navigation Satellite System (GLONASS), Quasi-Zenith Satellite System (QZSS) over Japan, Indian Regional Navigational Satellite System (IRNSS) over India, Beidou Navigation Satellite System (BDS), and/or the like. Moreover, the GNSS receiver 880 can be used with various augmentation systems (e.g., Satellite-based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 illustrated in FIG. 8 is illustrated as a component distinct from other components within a mobile device 800, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processing units, such as processing unit(s) 810, DSP 820, and/or a processing unit within the wireless communication interface 830 (e.g., in a modem). A GNSS receiver may optionally also include a positioning engine, such as those described herein (e.g., a an EKF/Kalman filter, WLS, particle filter, etc.), which can use GNSS measurements from the measurement engine and RTK/D GNSS correction information to determine a position of the GNSS receiver. The positioning engine may also be executed by one or more processing units, such as processing unit(s) 810 and/or DSP 820.

The mobile device 800 may further include and/or be in communication with a memory 860. The memory 860 may comprise a machine- or computer-readable medium, which can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the mobile device 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the mobile device 800 (and/or processing unit(s) 810 or DSP 820 within mobile device 800). In an aspect, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of if” used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of real-time precise positioning engine (PPE) measurement uncertainty modeling, the method comprising: for each epoch of a plurality of epochs, determining a respective value of pseudorange noise and multipath error of pseudo-range measurements performed by a global navigation satellite system (GNSS) device; determining one or more statistical values of the pseudorange noise and multipath error values for the plurality of epochs; determining a position error (PE) value based on the one or more statistical values; and for at least one epoch of the plurality of epochs, outputting an indication of the determined PE.
Clause 2. The method of clause 1, further comprising: determining a protection level (PL) based at least in part on the PE value; and for at least one epoch of the plurality of epochs, outputting an indication of the determined PL.
Clause 3. The method of any one of clauses 1-2 wherein, for each epoch of the plurality of epochs, determining the respective pseudorange noise value and the respective multipath error value is based on a difference in the respective pseudorange value for the respective epoch with a pseudorange value for the preceding epoch; and a difference in a carrier phase value for the respective epoch with a carrier phase value for the preceding epoch.
Clause 4. The method of any one of clauses 1-3 wherein the GNSS device comprises a mobile device or a Real Time Kinematics (RTK) base station.
Clause 5. The method of any one of clauses 1-4 wherein the PE value comprises a horizontal uncertainty of position error (HEPE) value and the PL comprises a horizontal protection level (HPL).
Clause 6. The method of any one of clauses 1-5 wherein the GNSS device comprises an RTK base station and wherein a mobile device performs the determining of the value of the respective pseudorange noise and the respective multipath error for each epoch of the plurality of epochs based, at least in part, on information received by the mobile device indicative of the pseudo-range measurements performed by the RTK base station.
Clause 7. The method of clause 6 further comprising, for the at least one epoch of the plurality of epochs determining a GNSS-based position of the mobile device based, at least in part, on the information received by the mobile device indicative of the pseudo-range measurements performed by the RTK base station; and outputting an indication of the GNSS-based position.
Clause 8. A mobile device for real-time precise positioning engine (PPE) measurement uncertainty modeling, the mobile device comprising: a transceiver; a memory; and one or more processors communicatively coupled with the transceiver and the memory, wherein the one or more processors are configured to: for each epoch of a plurality of epochs, determine a respective value of pseudorange noise and multipath error of pseudo-range measurements performed by a global navigation satellite system (GNSS) device; determine one or more statistical values of the pseudorange noise and multipath error values for the plurality of epochs; determine a position error (PE) value based on the one or more statistical values; and for at least one epoch of the plurality of epochs, output an indication of the determined PE.
Clause 9. The mobile device of clause 8, wherein the one or more processors are further configured to: determine a protection level (PL) based at least in part on the PE value; and for at least one epoch of the plurality of epochs, output an indication of the determined PL.
Clause 10. The mobile device of any one of clauses 8-9 wherein, for each epoch of the plurality of epochs, the one or more processors are configured to determine the respective pseudorange noise value and the respective multipath error value based on a difference in the respective pseudorange value for the respective epoch with a pseudorange value for the preceding epoch; and a difference in a carrier phase value for the respective epoch with a carrier phase value for the preceding epoch.
Clause 11. The mobile device of any one of clauses 8-10 wherein the GNSS device comprises the mobile device or a Real Time Kinematics (RTK) base station.
Clause 12. The mobile device of any one of clauses 8-11 wherein the PE value comprises a horizontal uncertainty of position error (HEPE) value and the PL comprises a horizontal protection level (HPL).
Clause 13. The mobile device of any one of clauses 8-12 wherein the GNSS device comprises an RTK base station and wherein the mobile device is configured to perform the determining of the value of the respective pseudorange noise and the respective multipath error for each epoch of the plurality of epochs based, at least in part, on information received by the mobile device indicative of the pseudo-range measurements performed by the RTK base station.
Clause 14. The mobile device of clause 13 wherein the one or more processors are further configured to, for the at least one epoch of the plurality of epochs: determine a GNSS-based position of the mobile device based, at least in part, on the information received by the mobile device indicative of the pseudo-range measurements performed by the RTK base station; and output an indication of the GNSS-based position.
Clause 15. An apparatus for real-time precise positioning engine (PPE) measurement uncertainty modeling, the apparatus comprising: means for determining for each epoch of a plurality of epochs, a respective value of pseudorange noise and multipath error of pseudo-range measurements performed by a global navigation satellite system (GNSS) device; means for determining one or more statistical values of the pseudorange noise and multipath error values for the plurality of epochs; means for determining a position error (PE) value based on the one or more statistical values; and means for outputting an indication of the determined PE for at least one epoch of the plurality of epochs.
Clause 16. The apparatus of clause 15, further comprising: means for determining a protection level (PL) based at least in part on the PE value; and means for outputting an indication of the determined PL for at least one epoch of the plurality of epochs.
Clause 17. The apparatus of any one of clauses 15-16 wherein, the means determining, for each epoch of the plurality of epochs, the respective pseudorange noise value and the respective multipath error value, is configured to base determining on a difference in the respective pseudorange value for the respective epoch with a pseudorange value for the preceding epoch; and a difference in a carrier phase value for the respective epoch with a carrier phase value for the preceding epoch.
Clause 18. The apparatus of any one of clauses 15-17 wherein the GNSS device comprises a mobile device or a Real Time Kinematics (RTK) base station.
Clause 19. The apparatus of any one of clauses 15-18 wherein the PE value comprises a horizontal uncertainty of position error (HEPE) value and the PL comprises a horizontal protection level (HPL).
Clause 20. The apparatus of any one of clauses 15-19 wherein the GNSS device comprises an RTK base station and wherein a mobile device is configured to perform the determining of the value of the respective pseudorange noise and the respective multipath error for each epoch of the plurality of epochs based, at least in part, on information received by the mobile device indicative of the pseudo-range measurements performed by the RTK base station.
Clause 21. The apparatus of clause 20 further comprising means for, for the at least one epoch of the plurality of epochs: determining a GNSS-based position of the mobile device based, at least in part, on the information received by the mobile device indicative of the pseudo-range measurements performed by the RTK base station; and outputting an indication of the GNSS-based position.
Clause 22. A non-transitory computer-readable medium storing instructions for real-time precise positioning engine (PPE) measurement uncertainty modeling, the instructions comprising code for: for each epoch of a plurality of epochs, determining a respective value of pseudorange noise and multipath error of pseudo-range measurements performed by a global navigation satellite system (GNSS) device; determining one or more statistical values of the pseudorange noise and multipath error values for the plurality of epochs; determining a position error (PE) value based on the one or more statistical values; and for at least one epoch of the plurality of epochs, outputting an indication of the determined PE.
Clause 23. The computer-readable medium of clause 22, wherein the instructions further comprise code for: determining a protection level (PL) based at least in part on the PE value; and for at least one epoch of the plurality of epochs, outputting an indication of the determined PL.
Clause 24. The computer-readable medium of any one of clauses 22-23 wherein the code for determining the respective pseudorange noise value and the respective multipath error value for each epoch of the plurality of epochs is configured to base the determining on: a difference in the respective pseudorange value for the respective epoch with a pseudorange value for the preceding epoch; and a difference in a carrier phase value for the respective epoch with a carrier phase value for the preceding epoch.
Clause 25. The computer-readable medium of any one of clauses 22-24 wherein the GNSS device comprises a mobile device or a Real Time Kinematics (RTK) base station.
Clause 26. The computer-readable medium of any one of clauses 22-25 wherein the PE value comprises a horizontal uncertainty of position error (HEPE) value and the PL comprises a horizontal protection level (HPL).
Clause 27. The computer-readable medium of any one of clauses 22-26 wherein the GNSS device comprises an RTK base station and wherein a mobile device is configured to perform the determining of the value of the respective pseudorange noise and the respective multipath error for each epoch of the plurality of epochs based, at least in part, on information received by the mobile device indicative of the pseudo-range measurements performed by the RTK base station.
Clause 28. The computer-readable medium of clause 27 wherein the instructions further comprise code for, for the at least one epoch of the plurality of epochs: determining a GNSS-based position of the mobile device based, at least in part, on the information received by the mobile device indicative of the pseudo-range measurements performed by the RTK base station; and outputting an indication of the GNSS-based position.

What is claimed is:

1. A method of real-time precise positioning engine (PPE) measurement uncertainty modeling, the method comprising:
for each epoch of a plurality of epochs, determining a respective value of pseudorange noise and multipath error of pseudo-range measurements performed by a global navigation satellite system (GNSS) device;
determining one or more statistical values of the pseudorange noise and multipath error values for the plurality of epochs;
determining a position error (PE) value based on the one or more statistical values; and
for at least one epoch of the plurality of epochs, outputting an indication of the determined PE.

2. The method of claim 1, further comprising:
determining a protection level (PL) based at least in part on the PE value; and
for at least one epoch of the plurality of epochs, outputting an indication of the determined PL.

3. The method of claim 1, wherein, for each epoch of the plurality of epochs, determining the respective pseudorange noise value and the respective multipath error value is based on:
a difference in the respective pseudorange value for the respective epoch with a pseudorange value for the preceding epoch; and
a difference in a carrier phase value for the respective epoch with a carrier phase value for the preceding epoch.

4. The method of claim 1, wherein the GNSS device comprises a mobile device or a Real Time Kinematics (RTK) base station.

5. The method of claim 1, wherein the PE value comprises a horizontal uncertainty of position error (HEPE) value and the PL comprises a horizontal protection level (HPL).

6. The method of claim 1, wherein the GNSS device comprises an RTK base station and wherein a mobile device performs the determining of the value of the respective pseudorange noise and the respective multipath error for each epoch of the plurality of epochs based, at least in part, on information received by the mobile device indicative of the pseudo-range measurements performed by the RTK base station.

7. The method of claim 6, further comprising, for the at least one epoch of the plurality of epochs:
determining a GNSS-based position of the mobile device based, at least in part, on the information received by the mobile device indicative of the pseudo-range measurements performed by the RTK base station; and
outputting an indication of the GNSS-based position.

8. A mobile device for real-time precise positioning engine (PPE) measurement uncertainty modeling, the mobile device comprising:
a transceiver;
a memory; and
one or more processors communicatively coupled with the transceiver and the memory, wherein the one or more processors are configured to:
for each epoch of a plurality of epochs, determine a respective value of pseudorange noise and multipath error of pseudo-range measurements performed by a global navigation satellite system (GNSS) device;
determine one or more statistical values of the pseudorange noise and multipath error values for the plurality of epochs;
determine a position error (PE) value based on the one or more statistical values; and
for at least one epoch of the plurality of epochs, output an indication of the determined PE.

9. The mobile device of claim 8, wherein the one or more processors are further configured to:
determine a protection level (PL) based at least in part on the PE value; and
for at least one epoch of the plurality of epochs, output an indication of the determined PL.

10. The mobile device of claim 8, wherein, for each epoch of the plurality of epochs, the one or more processors are configured to determine the respective pseudorange noise value and the respective multipath error value based on:
a difference in the respective pseudorange value for the respective epoch with a pseudorange value for the preceding epoch; and
a difference in a carrier phase value for the respective epoch with a carrier phase value for the preceding epoch.

11. The mobile device of claim 8, wherein the GNSS device comprises the mobile device or a Real Time Kinematics (RTK) base station.

12. The mobile device of claim 8, wherein the PE value comprises a horizontal uncertainty of position error (HEPE) value and the PL comprises a horizontal protection level (HPL).

13. The mobile device of claim 8, wherein the GNSS device comprises an RTK base station and wherein the mobile device is configured to perform the determining of the value of the respective pseudorange noise and the respective multipath error for each epoch of the plurality of epochs based, at least in part, on information received by the mobile device indicative of the pseudo-range measurements performed by the RTK base station.

14. The mobile device of claim 13, wherein the one or more processors are further configured to, for the at least one epoch of the plurality of epochs:
determine a GNSS-based position of the mobile device based, at least in part, on the information received by the mobile device indicative of the pseudo-range measurements performed by the RTK base station; and
output an indication of the GNSS-based position.

15. An apparatus for real-time precise positioning engine (PPE) measurement uncertainty modeling, the apparatus comprising:
means for determining for each epoch of a plurality of epochs, a respective value of pseudorange noise and multipath error of pseudo-range measurements performed by a global navigation satellite system (GNSS) device;
means for determining one or more statistical values of the pseudorange noise and multipath error values for the plurality of epochs;
means for determining a position error (PE) value based on the one or more statistical values; and
means for outputting an indication of the determined PE for at least one epoch of the plurality of epochs.

16. The apparatus of claim 15, further comprising:
means for determining a protection level (PL) based at least in part on the PE value; and
means for outputting an indication of the determined PL for at least one epoch of the plurality of epochs.

17. The apparatus of claim 15, wherein, the means determining, for each epoch of the plurality of epochs, the respective pseudorange noise value and the respective multipath error value, is configured to base determining on:
a difference in the respective pseudorange value for the respective epoch with a pseudorange value for the preceding epoch; and
a difference in a carrier phase value for the respective epoch with a carrier phase value for the preceding epoch.

18. The apparatus of claim 15, wherein the GNSS device comprises a mobile device or a Real Time Kinematics (RTK) base station.

19. The apparatus of claim 15, wherein the PE value comprises a horizontal uncertainty of position error (HEPE) value and the PL comprises a horizontal protection level (HPL).

20. The apparatus of claim 15, wherein the GNSS device comprises an RTK base station and wherein a mobile device is configured to perform the determining of the value of the respective pseudorange noise and the respective multipath error for each epoch of the plurality of epochs based, at least in part, on information received by the mobile device indicative of the pseudo-range measurements performed by the RTK base station.

21. The apparatus of claim 20, further comprising means for, for the at least one epoch of the plurality of epochs:
determining a GNSS-based position of the mobile device based, at least in part, on the information received by the mobile device indicative of the pseudo-range measurements performed by the RTK base station; and
outputting an indication of the GNSS-based position.

22. A non-transitory computer-readable medium storing instructions for real-time precise positioning engine (PPE) measurement uncertainty modeling, the instructions comprising code for:
for each epoch of a plurality of epochs, determining a respective value of pseudorange noise and multipath error of pseudo-range measurements performed by a global navigation satellite system (GNSS) device;
determining one or more statistical values of the pseudorange noise and multipath error values for the plurality of epochs;
determining a position error (PE) value based on the one or more statistical values; and
for at least one epoch of the plurality of epochs, outputting an indication of the determined PE.

23. The computer-readable medium of claim 22, wherein the instructions further comprise code for:
determining a protection level (PL) based at least in part on the PE value; and
for at least one epoch of the plurality of epochs, outputting an indication of the determined PL.

24. The computer-readable medium of claim 22, wherein the code for determining the respective pseudorange noise value and the respective multipath error value for each epoch of the plurality of epochs is configured to base the determining on:
a difference in the respective pseudorange value for the respective epoch with a pseudorange value for the preceding epoch; and
a difference in a carrier phase value for the respective epoch with a carrier phase value for the preceding epoch.

25. The computer-readable medium of claim 22, wherein the GNSS device comprises a mobile device or a Real Time Kinematics (RTK) base station.

26. The computer-readable medium of claim 22, wherein the PE value comprises a horizontal uncertainty of position error (HEPE) value and the PL comprises a horizontal protection level (HPL).

27. The computer-readable medium of claim 22, wherein the GNSS device comprises an RTK base station and wherein a mobile device is configured to perform the determining of the value of the respective pseudorange noise and the respective multipath error for each epoch of the plurality of epochs based, at least in part, on information received by the mobile device indicative of the pseudo-range measurements performed by the RTK base station.

28. The computer-readable medium of claim 27, wherein the instructions further comprise code for, for the at least one epoch of the plurality of epochs:
determining a GNSS-based position of the mobile device based, at least in part, on the information received by the mobile device indicative of the pseudo-range measurements performed by the RTK base station; and
outputting an indication of the GNSS-based position.
